(19) United States
(12) Patent Application Publication
(10) Pub. No.: US 2017/0355183 A1
(43) Pub. Date: Dec. 14, 2017

(54) METHOD FOR RECYCLING AT LEAST ONE MAGNET OF AN ELECTRIC MACHINE

(71) Applicant: AUDI AG, Ingolstadt (DE)

(72) Inventors: Tobias MENKE, Ingolstadt (DE); Lisa ZIESELER, Ingolstadt (DE); Alwin NAGEL, Esslingen (DE); Stephanie SCHWEIZER, Böbingen (DE)

(73) Assignee: AUDI AG, Ingolstadt (DE)

(21) Appl. No.: 15/616,321

(22) Filed: Jun. 7, 2017

(30) Foreign Application Priority Data
Jun. 8, 2016 (DE) 102016007038.2

(51) Int. Cl. B32B 43/00; H02K 15/00; H01F 41/02

(52) U.S. Cl. CPC B32B 43/006; H01F 41/0253; H02K 15/0006

(57) ABSTRACT

A method for recycling at least one magnet of an electric machine. A subassembly having the magnet is disassembled from the electric machine. In the process, the following steps are provided: carrying out a first thermal treatment of the subassembly at a first temperature, mechanical separation of the magnet from the subassembly, and carrying out a second thermal treatment of the magnet at a second temperature, which is higher than the first temperature, for debinding and/or cleaning of the magnet.

### FIELD

The invention relates to a method for recycling at least one magnet of an electric machine, wherein a subassembly having the magnet is disassembled from the electric machine.

### BACKGROUND

The magnet forms a part of the electric machine, which, for example, is associated with a motor vehicle. In particular, the electric machine represents a traction machine of the motor vehicle. The magnet exists in the form of a permanent magnet or at least has such a permanent magnet The permanent magnet is composed of a magnetic material, in particular of a hard magnetic material. Materials of this kind are an essential component of electric machines. Their magnetic properties crucially define the performance thereof.

The permanent magnet is present, for example, in the form of a sintered neodymium-iron-boron magnet. In comparison to other magnets, said magnets have a very high energy product. Therefore, in applications with a high requirement placed on power density—for example, in the case that the electric machine exists as a traction machine—permanent magnets of this kind are being increasingly used. In order to achieve a sufficient temperature stability of the magnetic properties of such magnets, the ternary compound (Nd₂Fe₁₄B) can be enhanced by addition of heavy rare earths, such as, for example dysprosium or terbium, and or other chemical elements, such as, for example, aluminum, cobalt, copper, or the like, and by other material engineering measures.

Because strong environmental pollution occurs during the extraction of the rare earths required for the permanent magnets, recycling of the permanent magnets has meanwhile taken on great importance. At present, however, no recovery of permanent magnets from motor vehicles is undertaken, so that the permanent magnets are fed together with other components of motor vehicles, to a shredder process. In the process, the metallic components undergo smelting for recovery of steel and aluminum, for which reason the valuable raw material from the permanent magnets is lost.

### SUMMARY OF THE DISCLOSURE

The object of the invention is to propose a method for recycling at least one magnet of an electric machine, said method having advantages in comparison to known methods, in particular, enabling the recovery of magnetic materials of high quality and/or the supply of a recycled magnet with very good magnetic properties, with the method being able to be utilized preferably also for a slanted rotor of the electric machine.

This is achieved in accordance with the invention by means of a method characterized by the following steps: carrying out a first thermal treatment of the subassembly at a first temperature, mechanical separation of the magnet from the subassembly, and carrying out a second thermal treatment of the magnet at a second temperature, which is higher than the first temperature, for debinding and/or cleaning of the magnet.

The electric machine has the magnet, it being possible for the magnet to be a component part of the subassembly of the electric machine. First of all, this subassembly is disassembled from the electric machine and then fed to the first thermal treatment. In the course of the first thermal treatment, the subassembly is brought to a first temperature, for example, to a temperature from 330° C. to 430° C., from 340° C. to 420° C. , from 360° C. to 400° C. from 370° C. to 390° C., or approximately of 380° C., in particular, exactly 380° C. The first thermal treatment serves, in particular, for a demagnetization of the magnet and/or for a partial decomposition of a magnet adhesive staging for fastening of the magnet and/or the separation of segmented individual magnets of the magnet, and/or a detachment of a sheet metal composite of the magnet.

The magnet is fixed in place, for example, in a sheet metal pan or sheet metal packet of the subassembly by means of the magnet adhesive. The individual magnets can also be fastened to one another by means of a magnet adhesive. The same magnet adhesive that is used for fixing the magnet in place in or at the sheet metal part or sheet metal packet can be used for this. For example, the first thermal treatment serves for the decomposition and, in particular, the full decomposition of the magnet adhesive serving for fastening the magnet at the sheet metal part. It can be provided, however, that the magnet adhesive, which binds the individual magnets together, is decomposed only partially or is not decomposed at all during the first thermal treatment.

Prior to carrying out the first thermal treatment, it can be provided that individual elements are removed from the subassembly. For example, the subassembly exists in the form of a rotor part of a rotor of the electric machine. The rotor has the rotor part containing the magnet, said rotor part being arranged, for example, on a shaft of the electric machine in a rotationally fixed manner. For example, the rotor part is pressed onto the shaft. In this case, the shaft can be pressed out of the rotor part and removed. The subassembly insofar, for example, is composed of at least one sheet metal part, in particular a sheet metal packet, and the magnet, with the magnet being fastened to the sheet metal part or the sheet metal packet by means of the magnet adhesive.

After the first thermal treatment, the magnet is mechanically separated from the subassembly. This can occur, for example, by means of a mechanical separation method, such as, for example, by shaking or vibration. After the separation, the magnet exists separately from the subassembly.

After the mechanical separation, the magnet, in particular the magnet alone, that is without any other elements of the subassembly, is fed to the second thermal treatment. The second thermal treatment occurs at a second temperature, which is higher than the first temperature. For example, the second temperature is at least 10 at least 15%, at least 20 %, at least 25% at least 30%, at least 35%, at least 40%, at least 45 %, or at least 50 % higher than the first temperature. For example, the second temperature is 450° C. to 550° C., 460° C. to 540° C., 470° C. to 530° C., 480° C to 520° C., 490° C. to 510° C., or approximately or exactly 500° C. The second thermal treatment serves for the debinding and/or cleaning of the magnet.

The method has the advantage that, in the case of a slanted rotor of the electric machine, it also enables the recycling of the magnet in a straightforward manner. In the case of such a slanted rotor, magnets arranged in succession in the direction of the longitudinal axis of the rotor are arranged offset to one another in the peripheral direction.

Another embodiment of the invention provides that the first temperature and/or a first time period, over which the first thermal treatment is carried out, are/is chosen in such a way that, during the first thermal treatment, a magnet adhesive that is present on the magnet is decomposed at least partially and, in particular, only partially. The purpose of the first thermal treatment has already been addressed above, as has the first temperature at which the subassembly is heated during the first thermal treatment.

The first time period is understood to mean the time period throughout which the subassembly is maintained at the first temperature. For example, the first time period has a duration of at least 30 minutes, at least 35 minutes, at least 40 minutes, at least 45 minutes, at least 50 minutes, at least 55 minutes, or at least 60 minutes. The first temperature and/or the first time period are/is chosen in such a way that the magnet adhesive, which is present at the magnet, is decomposed partially or fully. More preferably, only a partial decomposition is provided, so that, after the first thermal treatment, at least a part of the magnet adhesive exists in chemically unchanged form.

Another preferred embodiment of the invention provides that, by means of the separation carried out alter the first thermal treatment, a sheet metal part is mechanically separated from the magnet, in particular by shaking. Reference to this has already been made above. The separation occurs after the first thermal treatment, in particular directly after the first thermal treatment, it can be provided that the magnet is initially cooled prior to the separation, namely to a temperature that is lower than the first temperature. However, it can also be provided to undertake the separation while the magnet is at the first temperature. Through the separation, the sheet metal part is separated from the subassembly, that is, separated from the magnet. The separation is possible, in particular, because the magnet adhesive, by means of which the magnet is fastened to the sheet metal part, is already at least partially decomposed.

In the scope of another embodiment of the invention, it is provided that, after the first thermal treatment and prior to the second thermal treatment, the magnet is cooled to a temperature that is lower than the first temperature. The cooling can, for example, occur prior to the separation of the magnet from the subassembly. Alternatively, the cooling is provided after the separation. In both cases, prior to the second thermal treatment, the magnet is at temperature that is lower than the first temperature. However, it can also be provided that the magnet is separated from the subassembly at a temperature that is higher than the second temperature and lies, for example, between the first temperature and the second temperature or corresponds to the second temperature. For example, the separation is undertaken while the subassembly cools toward the second temperature*, but the latter has not yet been reached. Alternatively, the subassembly is held at the first temperature during the separation.

Another preferred embodiment of the invention provides that the second temperature and or a second time period, over which the second thermal treatment is carried out, are/is chosen in such a way that, during the second thermal treatment, the magnet adhesive present on the magnet is completely decomposed. When the magnet adhesive has been decomposed only partially during the first thermal treatment, the complete decomposition occurs during the second thermal treatment. To this end, the second temperature and/or the second time period are is chosen accordingly. For example, the magnet adhesive, which bonds or fastens the individual magnets of the magnet to one another, is decomposed, in particular, completely decomposed, during the second thermal treatment.

The second temperature lies, for example, in the region from 450° C. to 550° C. from 460° C. to 540° C., from 470° C. to 530° C. from 480° C. to 520° C. , from 490° C. to 510° C. or approximately or exactly at 500° C. The second time period has a duration, for example, that is longer than the duration of the first time period. The second time period is insofar longer than the first time period, in particular by a factor of at least 1.5, at least 1.75, at least 2, at least 2.25, or at least 2.5. For example, the duration of the second time period is about two hours.

In the scope of another embodiment of the invention, it is provided that the first temperature and/or the first time period are/is chosen in such a way that a corrosion coating of the magnet is completely retained and/or that the second temperature and/or the second time period are/is chosen in such a way that the corrosion coating of the magnet is completely decomposed. The corrosion coating basically can be of any kind; for example, it exists as an organic or as an inorganic corrosion coating. More preferably, the corrosion coating is a purely organic corrosion coating; that is, it has exclusively organic constituents.

In particular, the corrosion coating should be completely decomposed, if it is partially or completely organic, at least during the second thermal treatment. To this end, the second temperature and or the second time period are/is chosen accordingly. An inorganic corrosion coating can be retained—even completely. During the first thermal treatment, it can be provided that the corrosion coating, in particular the organic corrosion coating, is completely retained. Alternatively, it can also obviously be provided that the corrosion coating is completely decomposed already during the first thermal treatment, in particular if it is organic. In any case, the first temperature and or the first time period are/is to be chosen accordingly.

A further development of the invention provides that the first thermal treatment occurs under the influence of oxygen or under the exclusion of oxygen, and/or the second thermal treatment occurs trader the exclusion of oxygen or under less oxygen influence than during the first thermal treatment. Carrying out the thermal treatment under the influence of oxygen means essentially that the subassembly or the magnet is exposed during the corresponding thermal treatment to oxygen, which, in particular, is present as a constituent of ambient air. During the thermal treatment, the magnet or the subassembly therefore can be exposed to ambient air.

Alternatively, the thermal treatment can be carried out under the exclusion of oxygen. This can be realized, for example, by reduction of the oxygen partial pressure in comparison to ambient air. More preferably, the oxygen partial pressure is equal to zero or is at least nearly equal to zero, so that the magnet or the subassembly is not exposed to oxygen during the thermal treatment. Alternatively, the thermal treatment that is carried out under the exclusion of oxygen can be carried out in a partial vacuum or in a vacuum.

The first thermal treatment can be undertaken either under the influence of oxygen or under the exclusion of oxygen, with the former being preferred. The second thermal treatment, in contrast, should occur under the exclusion of oxygen or at least under less oxygen influence than during the first thermal treatment. This means that, preferably, the oxygen partial pressure in a medium enchasing the magnet or the subassembly is lower during the second thermal treatment than during the first thermal treatment. This is appropriate because the second thermal treatment is carried out at a higher temperature than the first thermal treatment, so that, when there is an excess influence of oxygen, an oxidation of the magnet or of the magnetic material forming the magnet could occur. This is presented reliably by the lesser oxygen influence or by reliably carrying out the second thermal treatment under the exclusion of oxygen.

Furthermore, it is possible in the scope of a preferred embodiment of the invention to provide that the magnet is treated in a material-removing manner after the second thermal treatment. In this way, for example, impurities on a surface of the magnet are to be removed. Additionally or alternatively, the treatment can serve to remove the corrosion coating. The material-removing treatment occurs, for example, by sandblasting, grinding, or similar methods.

An enhancement of the invention provides that the magnet is decomposed into a magnetic material and, in particular, is decomposed chemically and or mechanically, the decomposition of the magnet into the magnetic material is provided preferably after the second thermal treatment or after the material-removing treatment. The decomposition can basically be conducted in any way. The chemical decomposition is conducted, for example, by hydrogen embrittlement, which is carried out preferably under the exclusion of oxygen or in a protective gas atmosphere. The mechanical decomposition is conducted, for example, by grinding. It is also possible to undertake initially a chemical decomposition, in particular by hydrogen embrittlement, and then to decompose the magnet mechanically, in particular by grinding. The magnetic material results from the decomposition.

Finally, it can be provided that the magnetic material is processed under addition of one of the following substances to obtain a recycled magnet: fresh material and/or binder. The magnetic material obtained from the magnet is to be processed for recycling to a recycled magnet. To this end, it can be provided that fresh material and/or binder is added initially to the magnetic material. The fresh material is not to be understood as recycled magnetic material; that is, it is magnetic material obtained from raw materials.

Alternatively or additionally, the fresh material can also exist in the form of one or a plurality of individual constituents of the magnetic material or compounds thereof or it can contain them. Mentioned as examples or compounds are neodymium, neodymium hydroxide, FeNd, and DyF₃. The processing of the magnetic material to obtain a recycled magnet can be basically conducted in any way, such as, for example, by sintering. To this end, the magnetic material, which can be added to at least one of the substances mentioned, can be initially pressed and then sintered. Afterwards, a secondary heat treatment can be provided.

More preferably, the above-mentioned steps, in particular the first thermal treatment, the mechanical separation, the second thermal treatment, the material-removing treatment, and/or the decomposition into the magnetic material is/are carried out in controlled atmosphere. A controlled atmosphere is to be understood as meaning that the oxygen content of the atmosphere that is in contact with the magnet and/or the magnetic material is adjusted to a certain value. For example, this is conducted in such a way that, during the entire method, composed of the steps mentioned, an oxygen input into the magnet and/or into the magnetic material of at most 1 wt at most 0.9 wt %, at most 0.8 wt %, at most 0.7 wt. %, at most 0.6 wt %, or at most 0.5 wt % occurs. In this way, an outstanding temperature stability of the magnetic properties of the recycled magnet is achieved.

### BRIEF DESCRIPTION OF THE DRAWING

The invention will be discussed in detail below on the basis of the exemplary embodiments illustrated in the drawing, without any limitation of the invention thereby occurring. The sole FIGURE shows;

FIG. 1: a cross-sectional illustration through a subassembly of an electric machine.

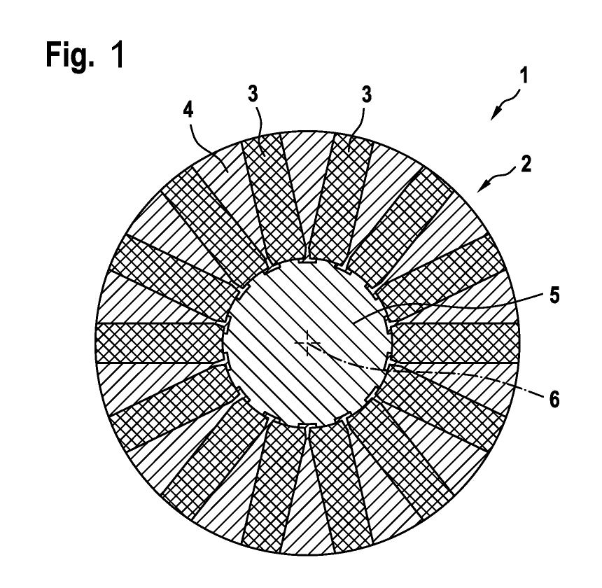

### DETAILED DESCRIPTION

The FIGURE shows a part of an electric machine 1 in cross section, namely a subassembly 2 of the electric machine 1. The subassembly 3 has at least one magnet 3 and, in the exemplary embodiment illustrated here, a plurality of magnets 3. The magnet 3 exists, for example, in the form of a permanent magnet. The magnet 3 is arranged in a sheet metal part 4 of the subassembly 2 or is held by it. The sheet metal part 4 is connected to the magnet 3 in a rotationally-resistant manner by a shaft 5. The shaft 5 serves for the rotatable bearing of the subassembly 2 around an axis of rotation 6 in the electric machine 1 or in a machine housing of the electric machine 1. The fastening of the magnet 3 to the sheet metal part 4 can be achieved by means of magnet adhesive.

For recycling of the magnet 3, the subassembly 2 is then initially disassembled ten the electric machine 1, in particular together with the shaft 5. Subsequently, it can be provided that the shaft 5 is detached mechanically from the subassembly 2 by, for example, pressing out the shaft 5 in the axial direction with respect to the axis of rotation 6.

Subsequently, the subassembly 2 is conveyed to a first thermal treatment at a first temperature and throughout a first time period. The first thermal treatment serves for the partial decomposition of the magnet adhesive present at the magnet 3. Subsequently, the magnet 3 is separated mechanically from the subassembly 2. This means, therefore, that the sheet metal part 4 is separated from the magnet 3. This can be carried out by shaking, for example. Other separation methods can also be provided, however. Afterwards, the magnet 3 is conveyed to a second thermal treatment at a second temperature and throughout a second time period. The second temperature is higher than the first temperature. Additionally or alternatively, the second time period is longer than the first time period. The second thermal treatment serves for the complete decomposition of the magnet adhesive.

After the second thermal treatment, it can be provided that the magnet 3 is treated in a material-removing manner by, for example, grinding and/or sandblasting. Subsequently, the magnet 3 is decomposed into a magnetic material, with this preferably being conducted chemically and/or mechanically. For example, the magnet 3 is initially cleaved chemically and then reduced in size mechanically. The former occurs, in particular, by means of hydrogen embrittlement, the latter by grinding. In this way, at recycled magnet can be produced from the obtained magnetic material. To this end, at least one additive can be added to the magnetic material, preferably with fresh material and/or a binder being used as the additive.

At least one of the thermal treatments is carried out preferably under the exclusion of oxygen. It can also be provided that the influence of oxygen during the first thermal treatment is greater than during the second thermal treatment. To this end, for example, the oxygen partial pressure during the second thermal treatment is lowered in comparison to the first thermal treatment.

It is possible by using the described method to recycle the at least one magnet 3 to produce a recycled magnet that has nearly the same magnetic properties as the magnet 3. This is achieved, in particular, by the two successive thermal treatments with the subsequent decomposition of the magnet 3 into the magnetic material.

1. A method for recycling at least one magnet of an electric machine, wherein a subassembly having the magnet is disassembled from the electric machine, comprising the following steps:
carrying out a first thermal treatment of the subassembly at a first temperature;
mechanically separating the magnet from the subassembly; and
carrying out a second thermal treatment of the magnet at a second temperature, winch is higher than the first temperature, for debinding and cleaning of the magnet.

2. The method according to claim 1, wherein the first temperature and a first time period, over which the first thermal treatment is carried out, are chosen in such away that, during the first thermal treatment, a magnet adhesive present at the magnet is decomposed at least partially.

3. The method according to claim 1, wherein, by means of the separation carried out after the first thermal treatment, a sheet metal part is separated mechanically from the magnet.

4. The method according to claim 1, wherein, after the first thermal treatment and prior to the second thermal treatment, the magnet is cooled to a temperature that is lower than the first temperature.

5. The method according to claim 2, wherein the second temperature and a second time period, over which the second thermal treatment is carried out, are chosen in such a way that, during the second thermal treatment, the magnet adhesive present on the magnet is completely decomposed.

6. The method according to claim 5, wherein the first temperature and the first time period are chosen in such a way that a corrosion coating of the magnet is retained completely, and wherein the second temperature and the second time period are chosen in such a way that the corrosion coating of the magnet is completely decomposed.

7. The method according to claim 1, wherein the first thermal treatment is conducted under the influence of oxygen, and the second thermal treatment is carried out under the exclusion of oxygen or under lesser influence of oxygen than during the first thermal treatment.

8. The method according to claim 1, wherein,-after the second thermal treatment, the magnet is treated in a material-removing manner.

9. The method according to claim 1, wherein the magnet is chemically or mechanically decomposed into a magnetic material.

10. The method according to claim 1, wherein the magnetic material is processed under addition of one of the following substances to yield a recycled magnet: fresh material and binder.
